(19) United States
(12) Patent Application Publication
(10) Pub. No.: US 2010/0023995 A1
(43) Pub. Date: Jan. 28, 2010

(54) Methods and Aparatus for Securing Access to Computer Libraries and Modules, The SecModule Framework

(76) Inventor: Jason W. Kim, Sunnyvale, CA (US)

Correspondence Address: Jason Won Kim, 1401 Marcello Dr, San Jose, CA, 95131, US

(21) Appl. No.: 11/777,510

(22) Filed: Jul. 13, 2007

(51) Int. Cl. H04L 29/06

(52) U.S. Cl. 726/1

(57) ABSTRACT

We have shown an efficient, easy-to-use framework which allows retrofitting of existing libraries, as well as develop new ones into a secured, session-managed environment. Our framework can be used for policy level enforcement (i.e. create enforceable, undeniable rules) for accessing, using, arbitrary code, functions and data held inside the library.

### CROSS-REFERENCE TO RELATED APPLICATIONS

Application Ser. No. 11/457,803 was filed on Jul. 15, 2007 as a Provisional patent, with a SB-14 clearly marking it as a provisional patent, but was misclassified by USPTO as a full utility patent. Currently, I am petitioning to reclassify Ser. No. 11/457,803 as a provisional patent. In case this petition is successful, then this application claims priority to U.S. Provisional patent application Ser. No. 11/457,803, filed Jul. 15, 2006. If the petition is unsuccessful, this application still stands as a full utility patent application, with no priority claimed.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

The present invention is related to methods and systems for the specification, authentication, and undeniable enforcement of Security Policies for the rights to access (or invoke the contents of) arbitrary Modules and Libraries. This invention can also be used to create a securely wrapped module (ref. SecModule) in which the described policies (or rules that govern the access rights to) are instilled. These Secured Modules, and the policies that govern how it may be used, accessed or invoked by a user (ref: a “client” for a SecModule) can then be distributed without fear of tampering, reverse engineering

### BRIEF SUMMARY OF THE INVENTION

Security policy enforcement and control over user programs traditionally operate by guarding the lowest level of the services provided by an operating system. While arguably secure and complete, these so-called “sandboxing” engines have a room for improvement. In this work, we discuss the system, implementation, performance, and ease-of-use aspects of a invention known as SecModule. This invention and framework allows arbitrary policy enforcements on the user's ability to invoke protected functions held securely inside a module.

In other words, SecModule allows the level of protection provided by a sandbox to the library level. SecModule gives the ability to place arbitrary policy level control over the rights to invoke arbitrarily complex functions held in libraries. An apt programming language analogy here is that existing sandboxes protect the primitive “assembly level” of possible operations provided by an Operating System. As software grows bigger and more complex, more useful evaluations and protection strategies are made possible by raising the protective shield to arbitrary compositions of such primitives, the same way that higher level programming languages allow programmers to be more productive in comparison to coding at the lowest level.

The prototype invention described herein can be used to build, use, and distribute such protected libraries, as well as the enforceable rules (i.e. security policies) that govern how the contents of that module can be used by the client. Discussions pertaining to SecModule's system security guarantees, performance issues, as well as ease-of-use factors follow.

### BRIEF DESCRIPTION OF THE FIGURES IN THE APPENDIX

| Appendix | Description | Page |
|---|---|---|
| A.1 | The SecModule Initialization Sequence | 23 |
| | Diagram of the various stages of SecModule call | |
| | cycle and their interaction. | |
| A.2 | Address Space Layout | 24 |
| | The logical-physical mappings of the memory pages | |
| | of the basic case SecModule client and server | |
| | processes. | |
| A.3 | Stack Manipulations | 25 |
| | Diagram of stack contents during a SecModule call | |
| A.4 | SecModule Policy State Machine | 26 |
| A.5 | A policy specification for libC | 26 |
| | An example of a SecModule Policy Specification. | |
| A.6 | An on-line policy | 26 |
| | Example of a SecModule Policy Specification that | |
| | uses run-time checks. | |
| A.7 | Full Address Space Layout | 27 |
| | Diagram of the complete logical-physical memory | |
| | mapping as used by SecModule. Also diagrams Signal | |
| | Service Processes | |
| A.8 | Timing Results for dd | 28 |
| | A graph that shows the measured elapsed time for | |
| | the UNIX dd command with varying block sizes | |
| A.9 | Timing Results for md5 | 29 |
| | A graph that shows the measured elapsed time for | |
| | md5 -a Sha256 command with varying file sizes | |
| A.10 | Context Switch Table 1 | 30 |
| | A graph that tabulates the number of (Voluntary | |
| | and Involuntary) of normal dd runs (with and | |
| | without systrace) | |
| A.11 | Context Switch Table 2 | 31 |
| | A graph that tabulates the number of (Voluntary | |
| | and Involuntary) of SecModule version of dd runs | |
| | (with and without systrace) | |
| A.12 | Policy Engine Performance Measurements | 32 |
| | A table of measured elapsed time for a basic no-op | |
| | SecModule call. | |

### DETAILED DESCRIPTION OF THE INVENTION

We discuss a prototype software invention, called SecModule, which was first described in our preliminary work[7]. This report covers additional research that complement our earlier results. In short, SecModule is a invention that can be used to implement policy level protection on the access to libraries and modules. From a computer security perspective, auditing whether a particular program is well behaved is a challenging task. Even when well known theoretical difficulties in testing for behavioral conformity are discounted, the (relatively) ad-hoc nature of software design and implementation makes answering—“will this program misbehave?” a challenging task.

To help answer that question, we develop an infrastructure and protocol for the formalization of access to software. SecModule is a novel, formal framework for building secured libraries and modules. It allows developers to create/port libraries of code that are session-managed. An authentication process is required for starting a session and to receive a “handle” through which the code in the library is invoked by the accessor. A Variety of controls can be enforced upon the behavior of the handle for custom tuning of security policies.

SecModule can complement existing sanboxing systems such as Janus[6] and Systrace[9] by allowing policy formulations to take effect at as a high a level in the software's abstraction hierarchy as needed, in addition to the system call guards they already provide.

Adding in authentication requirements and/or mandatory policy enforcement for calling of functions in a library is a very simple concept that is long overdue. Its very intuitive especially when thinking of computation as a protected resource.

This work answers the following questions:

1. What are the ways to generate a secure “handle” which will allow only processes that has successfully shown its valid credentials to allow to call or invoke functions within the library?

2. How are the risks of misusing the access handle minimized? That is, is it possible to limit the handle to be usable only by a validated process? In other words, only processes that have successfully authenticated should be given the ability to invoke the library method, and the handle must be valid only for a specific process.

3. What are the steps involved in creating a SecModule? How about SecModule applications?

4. What kinds of constructs are useful in specifying actual enforcement policies for libraries and modules? In short, what does the SecModule policy language look like? What operations are possible in the policy specification?

5. What are the software compatibility issues of enforcing policies on library function access?

6. What are the performance implications of having replacing normal libraries with the SecModule framework?

In the next section (1.1) We discuss additional background material which overlap with discussions in [7]. We then address questions 1 and 2 in section (1.2). Question 3, 4 and 5 are discussed in sections (1.3.2 - 1.3.4) respectively. We end section (1.3) with a summary discussion on security aspects of SecModule (Q 6) in section (1.3.5).

### 1.1 Background

In this section, we discuss additional background material as well as related works.

One very important item that can be thought of as a spiritual ancestor to our work was not by software engineers, but by hardware designers. To be more precise, the developers of the Intel 80286/80386 CPU foresaw the need for having a hierarchy of access rights to (important) pieces of software[1].

In their widely disseminated works, the Intel engineers describe a set of “protection rings” which denote the amount of privilege that the software belonging to that ring possess. The innermost (or level 0) is the most privileged, whereas the outer ring (level 3) is the least privileged user-level code. Their foresight is underreported today. Matter of fact, newer versions of Intel CPUs do not possess the full four level hierarchy, and make do with two privilege levels. To be fair, what the Intel engineers saw was the privilege separation between the kernel, and periphery code such as device drivers, and finally the user level code. Unfortunately, software engineering as a science had not quite reached that level when the 80386 was released, and many system developers chose to use a simpler model, grouping device drivers and other system services in the same realm as the OS kernel.

Remote Procedure Call[10] can also be thought of as an early example of a “session managed” access to functions. It has very wide spread use in networked environments, and is used to implement vital services such as Network File System (NFS)[2].

Traditionally, UNIX and variants all feature a coarse-grain binary privilege escalation. Access rights were associated with a specific login ID. Because of this, it was difficult to formulate and enforce a fine-grain policy with respect to library access. And access to functions, once given access to the library containing it, was automatic and irrevocable.

To state by analogy, what we desire is to effect a more flexible “security region” where access levels and regions are not necessarily discrete. In other words, the question of access must now be delegated to some sort of a computational process that can enforce a complex policy that may not respond to a discrete privilege level.

Towards this end, there have been some positive signs. The OpenBSD operating system (www. openbsd.org) prides itself in being an operating system geared towards security in mind. Secondly, also related to OpenBSD is Systrace[9] which can be used to generate and enforce a fine grain policy based control over applications in the system calls they invoke.

Systrace does an admirable job—its only drawback is that the behavior of software captured by systrace is (counter-intuitively) too verbose. Because systrace guards the lowest level services provided by the operating system, certain higher level actions wind up being difficult to discern. For example, opening a window on an X11 based application is achieved through a fairly large set of system calls—and the final end result of the creation of a new window is hidden beneath the massive amounts of verbiage generated by systrace.

In other words, when one thinks of the sequence of system calls needed to implement a complex operations found in existing system or user supplied libraries, the fine grain control supplied by systrace, by itself, is immediately insufficient for the task at hand. Even worse, it may introduce subtle problems if the sequence of system calls used for implementing a higher level functionality is inadvertently interrupted in the middle by a misconfigured system call policy—resulting in the library code being in an inconsistent state. Because of this chaining of system calls for higher level actions, it may also be difficult to phrase a sufficiently precise systrace policies for applications that use a higher level abstractions many layers removed from the system calls.

To address this issue, through SecModule, we raise the protective shield to the library level. In essence, we wish to provide fine grain policy enforcement over not just system calls, but calls to user level libraries as well. Our contribution is system which can be used to systematically formulate and formalize rights management for software. The access rights in question would be whether an entity p (which may be malicious) is allowed to execute some function ƒᵢ held secure in the library module m.

### 1.2 Generating a Secure Handle

A process p runs, and during its execution, p requests access to some function ƒᵢ contained in SecModule m. Initially, all images in m remain inaccessible to p. Once the request has been successfully processed, the SecModule system provides to p a handle h which allows access from p, and only p to ƒᵢ. The last criteria, to enforce that p and only p is allowed to access to ƒᵢ is ensured by the following:

The handle h, is a “co-process” that is started upon request for access to m. The actual dispatch to ƒᵢ in m is via an indirect call, managed by the OS Kernel.

Arguments and return values are marshaled and unmarshalled in the traditional stack passing mechanism, described next. The simplest policy is to allow access to m for the lifetime of p. Other policies may be implemented with this scheme.

A separate tool chain registers the SecModule m with the kernel, which must keeps track of the registered SecModules. At some point in time, the client process p, with credential c then makes a request to the kernel for access to the SecModule m. The kernel then verifies that c, is valid with respect to m's policy, and that m (consisting of name and version) actually is a registered SecModule. If so, then the kernel starts a new “co-process” h, linked with p, allowing a form of shared memory access between the two processes.

There are several problems in trying to share memory between processes using existing mechanisms (e.g. SystemV shared memory). First, any explicit shared memory model precludes sharing of large amounts of data. In fact, the required argument marshaling and unmarshalling develops the same flavor as that of the XDR (External Data Representation) Protocol used in RPC[10], and we were considering the generation of tools akin to rpcgen for SecModule.

It also became apparent that this design precluded its use for “retrofitting” much of the existing libraries into SecModules. The most fundamental call that was precluded was malloc ( ). Therefore, relying on an explicit shared memory model using existing OS primitives limits SecModule to “new” libraries.

The above problems go away if we presume that the processes p and h share the entire data, heap and stack portions of their virtual address space. It is important to point out that the text (or code) section is not shared between the client process and the handle. We achieved this by modifying several functions in the UVM[3] virtual memory subsystem of OpenBSD. With this approach, the handle has complete access to the entire data region of the client, such that even C library functions like malloc ( ) can be placed inside a SecModule, working identically to its man-page specification within the SecModule. Some functions in libc does need to be handled specially, discussed in section 1.3.4.

### 1.2.1 Security Implications for the Operating System

In this section we answer a question that was implicitly stated in the prior section.

Why is the code body of ƒᵢ mapped to the handle h instead of the requester process p?

The answer is simple. With the limitation that C, assembly or some derivation thereof, is used to develop the application that spawns the in-memory process p, there can be no trust placed on any memory portion directly under the control of p. The code for ƒᵢ can not be available to p, because then p can jump past any guard code that protects ƒᵢ directly to the important parts, negating any protective aspects.

Assuming that the user who owns p received the credentials legitimately, the requirement for allowing access to m is still there. So the obvious solution is to control access to each call to ƒᵢ through a kernel level call, to get around the restriction that p can not directly access the code body of ƒᵢ. The arguments for ƒᵢ are passed on the shared stack like a normal (non-SecModule) function call. Then p invokes ƒᵢ indirectly by invoking a new kernel method smod_call ( ) which will then verify that p did provide the proper credentials, and passes control over to h which will execute ƒᵢ on p's behalf.

This abstracted function call is not necessary if the OS and programming language itself did not allow arbitrary formulation of addresses and jumps, and code generation resources themselves are part of a trustworthy policy management. But such OS and language does not yet exist, and we are forced to accept this slowdown in order to increase the level of security.

In summation, the minimal set of changes needed in the OS are as follows:

1. Several new kernel level calls with the associated user level wrappers.

2. Several new functions, as well as modifications of existing functions in the virtual memory system.

3. Processes no longer generate a core image when they crash. Certainly no Handle process should! Otherwise, ƒᵢ can be easily stolen by the user.

4. ptrace( ) and related kernel calls must not allow tracing of any processes associated with the handle.

### 1.3 Implementation Details

The SecModule system is implemented on top of OpenBSD v3.6 running on an PentiumIII PC. Appendix A. 1 shows a high level overview of the steps by the client process p to access a function (in this case malloc ( )) held secure within the SecModule version of libc.

In step (1), the client's initialization code in crt0 tries to open access to the module that holds the routine we want to access. Once the kernel has acknowledged that the requested module exists, the client executes the smod_start_session ( ) call, which relays to the kernel the formal request by the client process for the module(s), each identified by a unique m_id. The smod_start_session ( ) needs a pointer to a structure that identifies all the modules requested by the client.

Assuming that the credentials check out, in step (2), the kernel forcibly forks the child process, creates a secret heap/stack segment for the handle, and executes the function smod_std_handle( ), using the secret stack. This secret stack is not available to the client. Refer to appendix A.2.

On step (3), the handle starts the first phase of the handshake by executing the smod_session_info( ) system call, which informs the kernel that the handle is ready to go. This system call also forcibly unmaps the entire data, heap, and stack segment of the handle process and forces it to share the memory pages from the same address range from the client process (Refer to appendix A.2). This system call may load in additional code segments as needed to fulfill the requirements of the module.

On step (4), the client process concludes the handshake by calling smod_handle_info ( ) which completes the internal synchronization data structures that the client and handle must use to communicate with each other. Then the client process's crt0 completes by executing the main routine for the client, called smod_client_main ( ).

Inside smod_client_main( ), in step(5), the client makes a call to malloc ( ) which is in reality a relay to SMOD_client_malloc( ). In step(6) The client stub routine invokes the kernel's smod_call( ) to start the actual call.

Some time later, in step (7), the handle receives the call, and relays the message to the real malloc( ) routine held inside it. Step (8) concludes by returning to the client.

Appendix A.2 gives a diagram of the address space of both the handle and the client processes. After the handshake completes as described above, the client process and the handle process is sharing the same pages for the address ranges that start just below the traditional OpenBSD data segment, to just above the end of the traditional OpenBSD stack segment bottom. All other portions are not shared. Specifically, the region marked “Secret Stack/Heap” is only available to the handle process's smod_std_handle ( ). The top half of that secret space is used as the stack space by smod_std_handle( ), to avoid colliding with the shared stack between the client and handle.

Now we describe in detail the calling sequence, in so far as the shared stack space is concerned. In Appendix A.3, step (1) shows the state of the stack inside the client's assembly stub routine (e.g. SMOD_client_malloc ( )), before the kernel level call to sys_smod_call ( ). Step (2) shows the state of the client's stack inside sys_smod_call ( ). Notice that the assembly stub routine pushed in the unique identifier pair module ID, funcID used to point to the function (and the module which contains it) that is being invoked. The top 2 elements from step (1) needed to be duplicated so that the kernel has the correct view of the relevant arguments. Technically, the kernel only requires client_FP_{—}1. However, using only that exposes the kernel to unnecessary architectural dependencies. Step (3) shows the same stack from the view point of the handle, inside the smod_stub_receive ( ), which is executed by the handle to accept the invocation. Note that the handle has popped off all of the unnecessary elements on the stack above arg1. At step (3), the handle then relays to the actual library routine named by module ID, func ID. The called function has access to the entire stack and data of the client process, as per normal (non SecModule) function call semantics. After the called function returns, in step (4), smod_stub_receive ( ) then replaces the exact same arguments that the client stub routine had seen, so that it can properly return to the original calling location.

It is important to note that the handle process actually executes smod_stub_receive ( ) using the secret alternate stack that was set up when the handle process initialized, shown in appendix A.2. Therefore, the execution of the handle-side stub routine can not disrupt the shared stack and data between the handle and client. In other words, smod_stub_receive ( ) sets the stack to the shared stack before relaying the call to the actual library routine.

### 1.3.1 Modifications Required in the Kernel

The implementation of SecModule can be broken up into three parts. First involves the sharing of the data and heap. The second involves the proper synchronization between the client and handle. The third portion deals with making sure that the executable code held in the module is not made available to the client inadvertently.

To achieve the first goal, we can follow two equally good approaches. First is to rely on the existing UVM interface to mark the address space between the data and the stack as shared, then fork ( ). The second approach is to forcibly unmap the pages in one process and to then forcibly map the pages from the other process onto the first. We chose the latter approach, and added several new function for the UVM[3] virtual memory system in OpenBSD to achieve this. The first function we added was uvmspace_force_share ( ) which uses existing UVM internal interface to first unmap all vm_map_entrys in the share region of the handle process, then to duplicate the actions of uvmspace_fork ( ) by duplicating (and sharing) the entries from the client's process for the address range.

We must also ensure that the relevant pages remain “shared” even as the client process's heap/stack grows and shrinks. For this, we needed to modify the low level uvm_fault ( ) routine, such that on a “unavailable mapping” error, uvm_fault ( ) examines the faulting address with respect to the other process, to see whether it has a valid mapping for that address. If so, then uvm_fault ( ) maps that entry onto the faulting address as a share. We also modified sys_obreak ( ) to request additional heap space as shared, if the request came for one of the process in a SecModule pair. We also modified uvm_map ( ) to create a shared mapping for the cases of the modified call from sys_obreak ( ).

The second goal of keeping the client and handle synchronized is much easier to achieve, as OpenBSD already comes with the proper kernel resources in the form of SYSV MSG interface. The msgsnd ( ) and msgrcv ( ) functions already contain efficient blocking and awakening that we desire for synchronization. So for the second goal, no changes were needed for testing purposes.

The third objective, of ensuring that the client process does not have direct access to the actual text of the functions held in a SecModule can be done in either one of two orthogonal approaches. The first approach is simply to encrypt the library using a secret key not revealed to the client process, using a a sufficiently powerful system like the the Advanced Encryption Standard[4]. We only encrypt regions in the library's text that do not correspond to relocation or linking data. That is, we do not touch any locations in the library that will need to be modified by the linking process. That way, the encrypted version of the library is still linkable using existing tools, but the unencrypted form will be available only to the handle process, after the kernel decrypts the relevant memory locations in the handle's text portion.

The second approach, which works well for dynamic libraries, is to simply have the kernel unmap the images of the shared library from the client's address space, as well as deny the ability of the client to load in plain text versions of the SecModule later on. As long as we can trust the fact that shared objects can only be directly accessed by the operating system, it is a perfectly valid way to maintain control over access to the libraries and remain carefree with regards to encryption.

There is nothing preventing both approaches being used, or using encryption to protect dynamically loaded libraries in a similar fashion.

### 1.3.2 Creating a SecModule, and Using it

The steps in creating a SecModule version of a library is a straightforward process. An in-depth explanation of the technical details behind this process is being prepared in [8].

First of all, the normal library archive which is to be converted is needed (say libc.a). Then the library archive is fed through a tool like objdump −t /usr/lib/libc.a |grep ′ F ′ to create a text file we refer to as a premanifest. Using the premanifest, the library archive, and an optional certificate (discussed in [8]), the first conversion of the library is registed to the SecModule via a command line tool repotool. repotool also generates several source code files in the repository which may need manual massaging in order for compilation and linking into a new smod-LIBNAMEvVERSION.a. Once this succeeds, the library is automatically registered once again as being ready for testing use. It is during this two step process that the client side assembly stubs are generated and linked in to the SecModule. The next step is to add in one or more policy specification files. At least one policy file aptly referred to as the “default” for that library is needed.

Using the SecModule libC is nearly identical to the traditional case, save that we must specify a custom linking procedure to make sure that the special crt0 is linked in, and that the objects that hold the name and version of the needed SecModules, as well as the policy enforcement code that control access to it are linked in. From the source code perspective, it is identical to the traditional case.

All of this is taken care of by sgcc, our gcc wrapper which behaves nearly identically with respect to gcc except for during link time. During linking, the specified policy enforcement code for each requested SecModule library is linked in to the application. sgcc is smart enough to know which “−1” flag refers to normal libraries and which ones are for SecModules.

### 1.3.3 The Policy Language

Within the SecModule invention, it is possible for the module implementor to place arbitrary restrictions and/or conditions that the client process must meet in order to receive invocation access rights to the module/function in question.

But first, we describe the actual policy decision process, which is a three-state machine.

The default state is to “deny access” to a module (and to all functions in held in that module). The other two states handle the statically determinable “always permit” and “evaluate online”, respectively. While in the “evaluate” phase, the policy enforcement code can choose to stay, or move to one of the other two states by evaluating a a conditional expression.

Within SecModule (as hinted earlier in 1.3.2), such enforcement rules are “compiled in” to the application at link time. The actual policy specification language allows for arbitrary controls over the access to a function held inside the module.

By arbitrary, we really do mean computationally complete. In short, the policy language for SecModule can be the main host language that the individual library is built in. See appendix A.5 for an example. Instead of chosing to implement a mini language with restricted features (such as ones found in systrace, KeyNote etc. . . . ), we instead allow the full programming power to be utilized by the programmer. In other words, one of the possible actions of the policy statement is to require that the policy decision depend upon the results of executing a function defined within the policy file.

Our policy file parser, policygen parses policy specifications like those in Appendices A.5 and A.6 to generate a source file that implement the specified policy.

For each requested SecModule, one policy engine gets linked in with application via sgcc. During the program initialization phase (inside the handle), each SecModule linked in to the application are initialized by executing its startup code. During this time, any statically determinable policy decisions (e.g. always permit, always deny) are made if possible and cached in an array allocated in the hidden heap.

A library can have multiple versions, and each version of a library can have multiple available policy files. Of course a single application is linked against only one version of an available library, as well as exactly one policy initialization code derived from one policy file among the many available. Our repository tool repotool and the gcc frontend sgcc also allow the notion of a “default” policy for a given library, so that for “default” applications, no additional changes to the sgcc command line is needed.

Except for the naked regular expressions paired with the “on function ACTION” syntax, the format of the policy file should be very familiar to C/C++ programmers. Matter of fact, after the close brace, rest of the policy file is treated as C++ source code which gets combined with the “expression tree” form of the policy commands to produce the on-line evaluation engine.

Using a high level language does come with the usual baggage of such languages, such as the inability to prove much about whether the policy statements (which rely upon the proper execution of functions defined within the policy file for the more interesting policies!) are actually sane, or even safe. Nevertheless, with a library of common functions that are made available to the library/module implementor, we hypothesize that most common cases of policy checks will be made available as a “design pattern” like suite. Initial reactions to our policy language has been relatively positive. The small context switch required for library implementors to design a policy for the module is seen as a positive trait.

There are architectural reason why we chose to use C++ instead of C. The full rationale is discussed in a report currently under preparation[8]. In short, there are two major reasons. First, it was easy to have the C++ Standard Template Library (http://www.sgi.com/tech/st1/) support complex data structures and algorithms that do NOT use the malloc( ) interface. (remember that any memory allocated by malloc( ) is shared between the handle and the client). The STL ADTs were probably the bare minimum in terms of functionality needed to create useful policy code. The second reason is that within our invention, it was easiest to have the policygen tool read/parse the policy definition file, and output C++ code that is linked in with the application.

This code actually initializes the expression tree that can be evaluated at run time to make on-the-spot decisions on whether a particular call is allowed or not. One special action of this policy tree is to call a policy-implementor defined function. This function can be as simple or as complex as needed.

The alternative was of course to output the expression tree flattened out into a datafile (which would entail designing and implementing the format as well as the I/O operations on said data format). The policy tree (i.e. the expression tree resulting after the parsing of a policy specification file) is easily built as a “tree type” and creating the dump( ) function that outputs the code to “rebuild” the tree on the fly was the simplest solution to take.

This approach allows policy implementor to use the declared map, vector and similar types that have been templated to use memory from the hidden heap for allocation purposes. Since the handle itself is executing in the hidden heap, any temporaries generated by the code is also invisible to the clients.

Currently, the SecModule toolchain does not feature useful utilities like interactive generation of policies (ala systrace!). However, it is relatively easy to design such an application as part of a policy engine. Since each and every call to all functions held in all SecModules can be audited on-line by policy-implementor defined code, that code can easily query an outside user whether to allow the call or not, and to save that information as a policy statement for future use. Although limitations of time have (thus far) precluded us from actively demonstrating such neat features, it is important to note that implementing such features in SecModule is a straightforward process.

### 1.3.4 Compatibility Issues

Certain function calls in the C library required special handling when they were converted over to the SecModule invention.

For execve ( ) and variants, the action taken at the kernel level is to first detach the requesting client process from the SecModule system, kill the associated handle process, and then to run sys_execve ( ) system call as per normal. If the resulting executable is a SecModule registered executable, its crt0 will correctly execute the required set of system calls to set up a new SecModule session.

For fork ( ) and variants, we duplicate the child process twice, and force the first child to be the handle for the second. This task is made complex by the fact that it is tricky to achieve a chained set of system calls on behalf of the child process after a fork( ). Thus some of the heavy lifting for fork is implemented as a handle-side code that sits outside of the kernel. Multiple clients should not share the handle, because a many-to-one mapping of clients to a single handle introduces a performance bottleneck.

Obviously, getpid ( ) and related calls must return the PIDs related to the client, not the handle! Similarly, signals (discussed in below), and scheduling routines like wait ( ) and their variants must be modified such that they effect the client, not the handle.

Signals were a challenge to implement properly, due to a myriad of issues. First of all, the way SecModule applications operate make it likely that a SecModule client will be executing smod_call ( ) when an interrupt occurs. Therefore, the method of how signals are handled by that call when it is delivered is the driving factor.

OpenBSD has an option for automatically restarting certain system calls on a signal receipt. Unfortunately, as of v3.6, this was not supported for the msgsnd( )/msgrcv( ) pair, which is used within smod_call ( ). To make it even worse, the concept of restarting a system call (sys_smod_call( )) that has nonlocal effects, and is actually composed of multiple system calls (which individually do not support the “restart” option) AND cross process boundaries is a fairly tricky feat.

Also to consider is that smod_call ( ) is inherently a distributed communications framework. It is difficult to envision what the signal/interrupt recovery technique would be to safely recover from a system level operation that works across two processes and four communications ops. The point of interruptions are many, and for each case, a different rollback/restart technique may be need.

For user level applications, we deal with the “interrupted system call” problem by restarting the msgsnd( )/msgrcv( ) operation if a signal is received during its execution. However, this can not be done inside the kernel because the breakout to userland must occur in order for the signal to be considered “delivered”. Without this breakout of the kernel, the signal does not get delivered completely, resulting in an infinite loop.

This means that in order for signals to work properly, we must either redesign how signal delivery works (which may entail messing with process scheduling), or how msgsnd ( )/msgrcv ( ) reacts to signals, or change the way how smod_call ( ) works.

It is possible to modify signal delivery mechanism and/or forcing msgsnd( )/msgrcv( ) to ignore signals but both were unattractive solutions. The signal delivery process and the required interactions between the scheduler and the kernel level is one of the more complex tasks in the modern OS, and is not to be done lightly. Allowing msgsnd( )/msgrcv( ) (or to be more precise, the SecModule versions of them) to ignore signals would make the processes immune to signals during execution of library calls and thus complicate recovery if something were to go wrong.

The third choice of modifying the smod_call ( ) protocol is unattractive for other reasons. In effect, we need to transform a single (apparently atomic) operation into a model that allows partial completion and restart. Refer to appendix (A.1). At steps 6 through 8, there are many distinct points of interruptions that can occur. Some of these are:

1. During the first msgsnd( ), but before the handle receives.

2. During the first msgrcv( ). Client is interrupted but the handle is not.

3. After the first msgrcv ( ) but before the relay to the actual library call.

4. During the actual library call relay

5. After the library call relay but before the second msgsnd( )

Absolutely the worst time for the interrupt to occur is after the actual library call has been executed (the data changes are now visible to the client and the handle), but before the client process receives the reply. Even if we were to use ad-hoc “checkpoint with event counter” techniques to keep track of where to restart, the added complexity in the kernel as well as the overhead would require additional careful studies, as well as leave room for possible security exploits of the client and handle going out of sync.

However, even with these issues, we can still support the signal facility upto the extent that they behave similarly (but not quite identically) with respect to the traditional UNIX signal handling.

We achieve this by adding in two new “signal service” (sigsrv for short) processes to the equation. They are called the SecModule signal service client, and the signal service handle. The job of the sigsrv client is to wait for signals to arrive and execute the appropriate handlers, as needed. The various signal handlers are allowed to execute SecModule calls, because the signal handlers would be communicating not the regular handle, but the signal service handle. Certain acrobatics need to be performed so that the smod_call ( ) s from the primary client, and smod_call ( ) s from the sigsrv client do not interfere with each other.

Useful work can be achieved by the sigsrv client as well as the sigsrv handle, because both share the entire memory address space of the primary client and the handle, respectively. That way, any data changes made by a signal handler is also immediately visible to the primary client (and thus the primary handle, as well as the signal service handle).

Finally, as an ease-of-use kludge, the sys_kill ( ) call was modified so that if any of the 4 processes are signaled individually, the actual signal is silently redirected to (or “swizzled to”) the signal service client process. The other related signal system calls (e.g. sigaction ( )) were modified so that the target of the action is silently swizzled to the sigsrv client process, because those calls (for registering the signal handlers and the like) are actually made by the primary handle process as part of the smod_call ( ) invocation sequence.

Process group signaling was left alone, on the theory that the kernel will signal all processes within a group simultaneously. This allows for things like seamless forced backgrounding (i.e. SI GTS TOP) of a SecModule application from the shell without additional hassles.

The result is that signal handling in SecModule does work remarkably close to traditional UNIX—at least on the surface, and simple applications can be compiled into SecModule without much hassles. The major difference “underneath the hood” is that signal reception and handling are now completely asynchronous with respect to the primary client process, and explicit synchronization between the sigsrv client and the primary client processes may be required for supporting certain actions.

Fundamentally, the signaling problem within SecModule is very much the same as when programmers try porting a traditional serially executing application into a distributed/parallel environment. In fact, signals in the SecModule environment are similar (conceptually speaking) to “signal via message passing” that occurs in distributed/parallel applications. The difference is that the actual message in question arrives in the form of a traditional signal based interrupt.

See appendix A.7 for details.

We hypothesize that trying to support the exact traditional model of signaling in full would require modifications to the OpenBSD process scheduler as the general kernel-code-to-user-code transitions that happens as part of signal handling. It may be possible to do this, but we settle on the easy solution for the time being. We do not foresee supporting set jmp ( ) and long jmp ( ) in the immediate future. (According the OpenBSD documentation, they are not supported within signal handlers anyway.)

One difficulty that has been solved has to do with the relatively innocuous errno variable. In order to insure proper functioning of existing applications, the errno variable must be saved by the client side assembly stub routine before the call to smod_call ( ). Once the handle receives the message, the saved errno value must be restored. Once the library call actually completes, errno must be saved once again, and then restored by the client side stub code before returning to the client. Without this 4-way handshake, some applications fail mysteriously or exhibit odd behaviors not observed during non-SecModule operations. This list of special requirements may not be exhaustive. There are nearly 1500 global text symbols in the OpenBSD libC. Auditing them for correct behavior within the SecModule will take some time, even for the most enthusiastic programmer. It needs pointing out that without the sharing of data/heap/stack, adding in access controls for access to existing libraries such as libC becomes much more difficult.

### 1.3.5 More Security Considerations

When considering encryption[5], it is important to note that the secret keys that wrap the individual functions in m (as well as the policy engine functions!) are never revealed to p. Once the SecModules are registered, the secret keys for each encrypted segment in m exist only in kernel space. As always, extreme care must be taken when choosing the pseudo-random keys for the symmetric cipher that actually protect the bulk of m.

In our test case, there are two principals, the SecModule implementor and the client. The creation and registration of the SecModule is handled by the same principal. However, in more realistic scenarios, The SecModule m exists in a truly multiuser environment, and there is a third principal, which is the system s that hosts m. In cases like this, s must be a trusted party and the secret keys that protect m are encrypted using s's public key, and is shipped as part of m. In both cases, the operating system which hosts m has to be a trusted party. If this is not the case, then a security prerequisite is not met, and SecModule's guarantees become invalid.

Handling multi-threaded client programs is a special challenge when auditing their behavior. As others point out[11, 12, 9], its is possible for multi-threaded clients to first give innocuous arguments, evade the permissions check, and then modify the arguments on the stack.

Preventing this attack in a user-land process is more difficult, but it can be done in several different ways. First, we can simply unmap the entire data and stack region of the client (including all threads) during the kernel level execution of sys_smod_call ( ). A second approach is to also forcibly remove the client (and all threads related to the client) from the ready queue. The second approach has the benefit of having lesser overhead for the kernel. However, neither approach is very desirable in terms of client efficiency. Other approaches like partially mapping a stack segment read only are fragile and not necessarily more secure than the two brute force approaches.

Technically speaking, the existence of the signal service client and handle makes the SecModule application a “multithreaded” one. However, it is unlikely that the a rogue user will be able to exploit the signal service client to swizzle arguments for the following reasons.

First of all, the sigsrv client shares memory with the client, not the handle, and is unable to directly influence the policy decision making process. Second, both the client and the sigsrv client are denied direct access to most system calls (obviously except for sys_smod_call ( ) and the like!). This blocking happens at the same level as where systrace does its permissions check—at the trap level before the actual system call ever gets executed. Matter of fact, after the client or the sigsrv client is allowed system call access, that call is still subject to audit by systrace. For these reasons, it is unlikely that the client will be able to spoof the system in order to trick the policy evaluation system.

Furthermore, any library calls (including those libC wrappers for system calls) are made by the sigsrv client through the same smod_call ( ) gate that gets serviced by the sigsrv handle process, which executes the the same policy evaluation as the normal handle. Lastly, as a precautionary measure, signal delivery to the sigsrv client is prevented at the kernel's psignal ( ) level while the client process is executing smod_call ( ). It may also be necessary to prevent the client from executing additional library calls while the sigsrv client is actively servicing a signal by placing an additional kernel level guard code at the beginning and end of signal handler execution. Additional investigations in this area are continuing.

### 1.3.6 Performance Characteristics

Measurements are detailed in the following appendices A.8 through A.12. For reference, refer to my earlier work [7] which discuss fundamental low-level performance characteristics of SecModule use.

For our experiments, we first ported over versions of libc and libutil into the SecModule framework using our repository tools, and compiled several small applications (e.g. cp, rm, cat, dd, etc. . . . ) in the /usr/src/ tree into the SecModule invention. The application sources were instrumented with getrusage ( ) based timing code at the start of main ( ) and atexit ( ) so that the startup and end costs would not be a factor in our measurements.

In our tests, we used two different executables, (both identically instrumented for timing purposes) but one compiled normally, and one compiled into the SecModule invention. For the most part, once the libraries have been ported and reported to the system, compiling the OpenBSD applications into the Sec-Module framework were accomplished by make CC=“sgcc —policy C=debugging —policy util=debugging −Dmain=smod_client_main”. Refer to earlier discussion in 1.3.2, for steps in porting existing or new libraries into SecModule.

Each run of our tests were made at least 10 times. The first test is on file system access (read-write) performance. Normal, normal with systrace enabled, SecModule, and with SecModule enabled.

Our first test verifies that the costs of SecModule calls can become appreciable if the calls do relatively little work. Appendix A.8 show that for small block sizes, the run times of the SecModule version of dd are appreciably slower than the normal version.

As expected (and reported in [9]), we verified that at least for “always allowed” processing, the burden of running systrace on top of SecModule is minimal.

For CPU bound tasks, we chose the md5 utility identically instrumented as above. Appendix A.9 shows the run time of md5 -a sha256 on files of various sizes. Strangely enough, this test results show that the SecModule version of md5 ran slightly faster than the normal versions. This is strangeness is repeatable, but not very significant. The shell utility /usr/bin/time reports that on the average the SecModule version of md5 incurs a slightly lower user time, even though the total execution time for the SecModule version of md5 is actually slightly longer. Since the instrumented apps only report the times incurred (user+sys) between the start of main ( ) and exit ( ), the additional lag is not counted. As expected, systrace adds a barely noticeable overhead to the respective run times.

The next two appendices explain the timing discrepancy between the normal versions of dd and the SecModule variant.

For the normal case (in appendix A.10), the number of voluntary and involuntary context switches are relatively reasonable. However, as shown in appendix A.11, the number of voluntary context switches for SecModule version of dd skyrocket. This is because each and every library access in a SecModule application call is mediated by the kernel. More system calls obviously has to equal more systrace (as well as SecModule) overhead.

Our last result for this report show the performance numbers for the absolute minimum on-line evaluation. Recall from section (1.3.3) that the policy engine has two states (always permit, always deny) that are very efficient. The third state, or the on-line evaluation state actually requires that the policy expression tree is evaluated and/or a library-developer defined decision making function be invoked. It is the performance of this online evaluation that is presented below in appendix A.12.

First, we measure the requirements for dynamically building the policy expression tree for a simple single-statement policy for libC in appendix A.6.

It goes without saying that more complex policy files will scale up with respect to the amount of time it takes to recreate the required policy expression tree. In comparison to the base line performance measurements reported in [7], the minimal cost of the in-handle on-line evaluation that returns “permit now” code is not much more than the cost of a basic system call. Because the evaluation takes place in user land (albeit one which is isolated from the client), the performance measurements hold no surprises.

### REFERENCES

[1] The Intel IA-32 Software Architecture Manual. Intel, 2001.

[2] B. Callaghan, B. Pawlowski, and P. Staubach. RFC1813: NFS Version 3 Protocol Specification, 1995.

[3] Charles D Cranor. DESIGN AND IMPLEMENTATION OF THE UVM VIRTUAL MEMORY SYSTEM. PhD thesis, Sever Institute, Washington University, August 1998.

[4] Joan Daemen and Vincent Rijmen. The design of Rijndael: AES—the Advanced Encryption Standard. Springer, 2002.

[5] W Diffie. The first ten years of public-key cryptography. In Proceedings of the IEEE, volume 76, pages 560-577, May 1988.

[6] Ian Goldberg, David Wagner, Randi Thomas, and Eric A Brewer. A Secure Environment for Untrusted Helper Applications. In In Proceedings of the 6th USENIX Security Symposium, July 1996.

[7] Jason W Kim. Base Line Performance Measurements of Access Controls For Libraries and Modules. In The 2nd International Workshop on Security in Systems and Networks (SSN2006) (To appear), Rhode Island, Greece, April 2006. Held in Conjunction with International Parallel and Distributed Processing Symposium (IPDPS).

[8] Jason W Kim and Jaswinder Singh. Effective Generation and Catagorization of Security Policies for Access to Libraries and Modules. Technical Report Under Preparation, Drexel University, 2006.

[9] Neils Provos. Improving Host Security with System Call Policies. In 12th USENIX Security Symposium, pages 257-272, 2003.

[10] R. Srinivasan. RFC1831: RPC: Remote Procedure Call Protocol Specification Version 2, 1995.

[11] David Wagner and Drew Dean. Intrusion detection via static analysis. In Proceedings of the IEEE Symposium on Security and Privacy, May 2001.

[12] David Wagner and Paolo Soto. Mimicry attacks on host-based intrusion detection systems. In Proceedings of the 9th ACM Conference on Computer and Communication Security, November 2002.

I claim:

1. this invention comprises of methods and systems for the
creation
protection
distribution
use and efficient execution
of Secured Libraries and Modules (ref: a SecModule) by any interested party (ref: SecModule implementor)

2. The methods and systems described in this invention can be used for the
creation
specification
testing,
enforcement
modification
of arbitrary security policies that govern how the Secured Module (ref. SecModule) referred to in claim 1 can be accessed and/or by a user of the Secured Module (ref: the “client”), The security policy is compiled into the application or library such that is verifiable, computable, and enforceable by SecModule,

3. the methods in claim 1 to guarantee the contents of the Secured Module (ref SecModule) referred to always remain securely encrypted, and thus tamperproof to the limits of the encryption technologies used,

4. the the methods in claim 1 to guarantee Secured Module (ref SecModule) are made linkable with existing computer tools to create other executables, even when encrypted, via the methods and systems described herein,

5. the methods in claim 1, for, and the method of, selective sharing of memory pages between the handle (e.g. server) and the client such that the functions being executed by the handle on behalf of the client gets to access the entire data, heap, and stack space of the client process, but not the text.

6. methods in claim 1 for guaranteeing run time security in the SecModule operating environment, which guards both the library module itself as well as any policy specifications held inside it.

7. The methods in claim 1, applicable to all existing and future operating environments—that additional security measures, including but not limited to, random splitting, obfuscation, function renaming, control flow morphing can be applied in either in part or whole to any function, procedure, method or object dispatch within a SecModule to defeat reverse engineering attacks even when the encryption keys are compromised.

8. the methods in claim 1 that apply existing operating system facilities are utilized to ensure SecModule users (ref: the user's process, or “client”) are granted efficient access to the resources held within a SecModule through selective, enforceable, revokable sharing of memory pages between the client's process,

9. the methods in claim 1 that guarantee the cost overhead of accessing a code, function, or data held inside a SecModule is within established boundaries of the absolute minimum cost incurred for a context switch of processes executing within the operating system in which the SecModule is installed,

10. the methods in claim 1 to guarantee that actual Library/Module (ref SecModule) always remain protected against direct access, that this invention allows a SecModule implementor (ref: entity who creates a SecModule for other's access and use) absolute control over the ability, or the rights of a client (ref: SecModule user) to invoke the code, functions, procedures, object methods, data held securely within the SecModule through the policy specifications referred to above in claim 2

11. the methods in claim 1 to guarantee a library or module's functionality (or the behavior and state of any code, function or data held within the library or module) remains identical, or does not change substantively when converted to a SecModule via the methods and systems described herein, such that a SecModule is fundamentally compatible with the traditional form of libraries and modules, and can be a drop-in replacement for the traditional library/module,

12. the methods in claim 1 to guarantee that through the creation and use of a SecModule and accompanying policies, implementors as well as authorized users (ref: clients) can debug, experiment, measure and otherwise develop and revise the SecModule according to the needs at hand.

13. The methods in claim 2, applicable to all existing and future operating environments—i.e. the security properties that govern the behavior the handle and client are expressed in a policy specification language that can be same or different from the language used to develop the library.

14. The methods in claim 2 which ensures the policies SecModule implementor (ref: the entity who creates the Secured Library/Module) can specify can be as simple, or as complex as necessary,—i.e. is computationally complete.

15. The methods in claim 2 which allows the the policy specification language can be used to directly define commercial or noncommercial licenses for end-users of the SecModule system and the policies that the SecModule implementor (ref: the entity who creates the Secured Library/Module) can specify are in fact computationally complete, supporting arbitrary business models.

16. The methods in claim 2—that additional security measures, including but not limited to, random splitting, obfuscation, function renaming, control flow morphing can be applied in either in part or whole to any function, procedure, method, data, or object dispatch within a SecModule, including the policy specification itself, such that even while a user of a SecModule is actively seeking to compromise or exploit, functions, procedures, methods data and policies held within the SecModule remain secure.

17. The methods in claim 2 to guarantee that through the creation and use of a SecModule and accompanying policies, implementors can debug, experiment, measure and otherwise develop and revise the policies governing the use of a SecModule according to the needs at hand, independently of the SecModule and clients to which the policy applies to.

18. All methods and systems described in invention applies to all major computer operating systems and hardware, including but not limited to OpenBSD, OS X, Linux, Microsoft Windows 2000/XP/Vista, Intel x86 architectures, PowerPC architectures, Sun Microsystems Architectures, as well as any future architectures and operating environments.
